(19) United States
(12) Patent Application Publication
(10) Pub. No.: US 2015/0220692 A1
(43) Pub. Date: Aug. 6, 2015

(54) METHOD FOR PROVIDING REAL TIME CLAIMS PAYMENT

(71) Applicant: VBA Virtual Benefits Administrator, Germantown, WI (US)

(72) Inventors: Thomas W. Witter, Wauwatosa, WI (US); Stephen M. Janecko, Allison Park, PA (US); Merill Pierce, Columbia, IL (US)

(21) Appl. No.: 14/616,188

(22) Filed: Feb. 6, 2015

Related U.S. Application Data
(60) Provisional application No. 61/936,583, filed on Feb. 6, 2014.

(51) Int. Cl. G06F 19/00; G06Q 20/10

(52) U.S. Cl. CPC G06F 19/328; G06Q 40/08; G06Q 20/102

(57) ABSTRACT

A system for real time payment of insurance claims is disclosed. As an initial step, patients provide their insurance information to a service provider. The service provider transmits the patient's information and the insurance information to a benefits administrator. The benefits administrator determines whether the patient is participating in a plan provided by the insurance provider that provides for real time payment of the insurance claim. If the patient is participating in an eligible plan, the benefits administrator informs the service provider. The service provider submits a claim describing the services provided to the patient. The benefits administrator identifies the services for which payment may be made in real-time. The benefits administrator coordinates payment from the insurance provider to the service provider and sends a confirmation of the payment to the service provider. The benefits administrator may additionally provide an explanation of benefits in real time to the patient.

### CROSS-REFERENCE TO RELATED APPLICATIONS

This application claims priority to U.S. provisional application Ser. No. 61/936,583, filed Feb. 6, 2014, the entire contents of which is incorporated herein by reference.

### BACKGROUND OF THE INVENTION

The subject matter disclosed herein relates generally to a system for payment of insurance claims and, more specifically, to a system that processes insurance claims and provides payment on approved claims in real time.

As is known to one skilled in the art, health care costs have been growing at a significant rate. Many factors contribute to this growth, such as new technology, increasing demand from an aging population, inflation, and the like. Another factor in the cost of health care are administrative costs, such as office staff, accounting, claims processing, and the like. Presently, service providers are required to submit claims to insurance providers and/or benefits administrators, correct errors in claims, as required, wait for approval, and wait for payment. The process may even be repeated if a patient has primary and secondary insurance providers. An invoice is then submitted to the patient for the portion of the cost of the services provided that were not covered or adjusted by the insurance provider. The process results in uncertainty for the service provider with respect to when a payment for services will be received and in the amount of the payment. Thus, it would be desirable to provide an improved system for processing and paying insurance claims.

### BRIEF DESCRIPTION OF THE INVENTION

The subject matter disclosed herein describes a system for real time payment of insurance claims for service providers. As an initial step, patients provide their insurance information to the service provider. The service provider transmits the patient's information and the insurance information to a designated benefits administrator. The benefits administrator determines whether the patient is participating in a plan provided by the insurance provider that provides for real time payment of the insurance claim. If the patient is eligible for services and is participating in a qualified plan, the benefits administrator provides patient authorization to the service provider. Upon completion of providing services to the patient, the service provider submits a claim describing the services provided. The benefits administrator identifies the services for which payment may be made in real-time. The benefits administrator coordinates payment from the insurance provider to the service provider for those services and sends a confirmation of the payment to the service provider. The benefits administrator may additionally provide an explanation of benefits in real time as well as follow up information to the patient.

According to one embodiment of the invention, a method for real-time claims payment is disclosed. A claim submission is generated with a practice management system executing on a computer at a service provider. The claim submission identifies at least one service provided. The claim submission is transmitted from the computer at the service provider to a remote server at a benefits administrator via a network. A claim processing system executing on the remote server verifies that the claim submission is a clean claim. A payment is initiated in real-time from the claim processing system for the service provided, and the payment is credited to an account for the service provider, A payment acknowledgement is transmitted from the claim processing system on the remote server to the claim management module executing on the computer at the service provider via the network in real-time.

The method for real-time claims payment may also execute initial steps to determine whether a patient's insurance is eligible for real-time claims payment. The patient's insurance information is entered in the practice management system and an eligibility request is generated with a claim management module executing on the computer at the service provider. The eligibility request includes the patient's insurance information. The eligibility request is transmitted from the computer at the service provider to the remote server via the network. An insurance provider is extracted from the patient's insurance information in the eligibility request with the claim processing system, and the insurance provider is verified as being eligible for real-time claims payment. An eligibility response is generated with the claim processing system on the remote server and transmitted from the remote server to the claim management module executing on the computer at the service provider via the network. The eligibility response identifies whether the insurance provider is eligible for real-time claims payment.

According to other aspects of the invention, the claim submission, the payment acknowledgment, the eligibility request, and the eligibility response may each be formatted as an Electronic Data Interchange (EDI) message. The step of entering a patient's insurance information may include reading either an identity of a patient or the patient's insurance information with a patient interface device.

According to another aspect of the invention, the step of verifying that the claim submission is a clean claim may include the steps of reading a model data portion stored on a memory device operatively connected to the remote server, and verifying that a format of each segment of a data portion of the first EDI message corresponds to the desired format for each of the plurality of segments in the model data portion. The model data portion corresponds to the service provided and defines multiple segments of the EDI message and a desired format for each of the segments. The step of verifying that the claim submission is a clean claim may further include the steps of identifying at least one error between the format of one segment of the data portion of the first EDI message and the desired format for the corresponding segment in the model data portion, correcting the error such that the format of the segment of the data portion of the first EDI message matches the desired format for the corresponding segment in the model data portion, and again verifying that the format of each segment of the data portion of the first EDI message corresponds to the desired format for each of the plurality of segments in the model data portion.

According to another embodiment of the invention, a method for real-time claims payment receives a claim submission from a service provider at a remote server via a network, where the claim submission identifies at least one service provided. A claim processing system executing on the remote server verifies that the claim submission is a clean claim and initiates a payment in real-time for the at least one service provided to an account for the service provider. A payment acknowledgement is transmitted from the claim processing system on the remote server to the service provider via the network in real-time.

An eligibility request may initially be received from a claim management module executing on the computer at the service provider by the remote server via the network. The eligibility request includes insurance information for a patient visiting the service provider. The claim processing system extracts an insurance provider from the patient's insurance information in the eligibility request and verifies that the insurance provider is eligible for real-time claims payment. The claim processing system on the remote server generates an eligibility response identifying whether the insurance provider is eligible for real-time claims payment and transmits the eligibility response from the remote server to the claim management module executing on the computer at the service provider via the network.

According to yet another embodiment of the invention, a method for real time claims payment generates a first Electronic Data Interchange (EDI) message, corresponding to a claim submission, with a practice management system executing on a computer at a service provider. A data portion of the first EDI message identifies at least one service provided. The first EDI message is embedded within a transport protocol configured to be transmitted on a network and transmitted via the network from the computer at the service provider to a remote server at a benefits administrator. The first EDI message is extracted from the transport protocol at the remote server, and a claim processing system executing on the remote server verifies that the data portion of the first EDI message defines a clean claim. An Automated Clearing House (ACH) transaction is generated in real-time from the claim processing system for the at least one service provided, where the ACH transaction includes details of payment to the service provider for the service provided. A second EDI message, corresponding to a payment acknowledgement, is generated with the claim processing system on the remote server and embedded within the transport protocol. The second EDI message is transmitted from the remote server to the computer at the service provider via the network and extracted from the transport protocol at the service provider. The payment for the service provided is credited to the patient at the service provider.

These and other objects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWING(S)

Various exemplary embodiments of the subject matter disclosed herein are illustrated in the accompanying drawings in which like reference numerals represent like parts throughout, and in which:

FIG. 1 is a block diagram representation of an exemplary system incorporating one embodiment of the present invention;

FIG. 2 is a flowchart illustrating an overview of the steps for real time payment of a claim according to one embodiment of the present invention;

FIG. 3 is a flowchart illustrating the additional steps of authorizing eligibility as shown in FIG. 2;

FIG. 4 is a flowchart illustrating the additional steps of creating a claim as shown in FIG. 2;

FIG. 5 is a flowchart illustrating the additional steps of real time auto adjudication of a claim as shown in FIG.

FIG. 6 is a flowchart illustrating the additional steps of real time payment of a claim as shown in FIG. 2;

FIG. 7 is a flowchart illustrating the additional steps of following up with a patient as shown in FIG. 2;

FIG. 8 is a block diagram representation of an exemplary Electronic Data Interchange message utilized according to one embodiment of the invention; and

FIG. 9 is a block diagram representation of the Data portion of the EDI message of FIG. 8.

In describing the preferred embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION OF THE PREFERRED EMBODIMENTS

The various features and advantageous details of the subject matter disclosed herein are explained more fully with reference to the non-limiting embodiments described in detail in the following description.

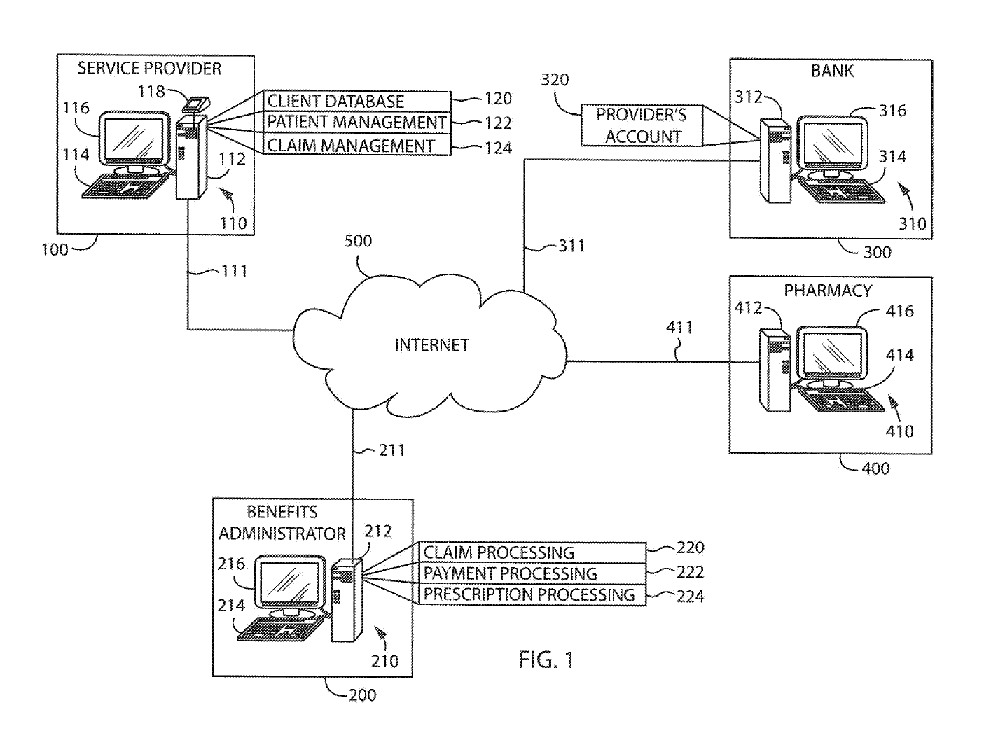

Turning initially to FIG. 1, a service provider 100 for medical care, such as a doctor's office, health-care clinic, or hospital, includes a computer system 110 to manage patient data. The computer system 110 may include one or more computers, servers, workstations, terminals, or combinations thereof at various locations throughout the facilities of the service provider 100. An exemplary computer includes a processing unit 112, a user interface 114, such as a mouse, keypad, trackball, or touch-screen, and a monitor 116. The processing unit 112 includes an internal memory device, such as a hard-drive, or is connected to an external memory device which stores a client database 120. It is contemplated that the external memory device may be, for example, a local device such as an external hard-drive or a remote device, such as a remote server. The processing unit 112 is configured to execute one or more applications, including, but not limited to a Practice Management System (PMS) 122 and a claim management module 124. It is further contemplated that each of the PMS 122 and the claim management module 124 may be integrated into a single application or may be comprised of multiple other applications. The processing unit 112 is connected to the Internet 500 via any suitable network interface 111. The computer system 110 may further include one or more patient interface devices 118. The patient interface device 118 may include a near field communication (NFC) device configured to communicate, for example, using a standard wireless protocol, such as Bluetooth, to a patient device, such as a mobile phone or tablet computer. Optionally, the patient interface device 118 may include a biometric scanner to determine the identity of the patient or a scanner configured to read an image, such as a QR code on a patient's electronic device, or a magnetic strip on a patient's identification card.

A benefits administrator 200 includes a computer system 210 to process claims received from the service provider 100. The computer system 210 may include one or more computers, servers, workstations, terminals, or combinations thereof at various locations throughout the facilities or at multiple locations of the benefits administrator 200. One server may be dedicated, for example, to claims processing and another to claims adjudication. Optionally, a single server may handle both functions. An exemplary computer includes a processing unit 212, a user interface 214, such as a mouse, keypad, trackball, or touch-screen, and a monitor 216. The processing unit 212 includes an internal memory device, such as a hard-drive, or is connected to an external memory device. It is contemplated that the external memory device may be, for example, a local device such as an external hard-drive or a remote device, such as a remote server. The processing unit 212 is configured to execute one or more applications, including, but not limited to a claim processing system 220, a payment processing system 222, and a prescription processing system 224, it is further contemplated that each of the claim processing system 220, payment processing system 222, and prescription processing system 224 may be integrated into a single application or may be comprised of multiple other applications. The processing unit 212 is connected to the Internet 500 via any suitable network interface 211. According to still another embodiment of the invention, the processing unit 212, the external storage connected to the computer system 210, or a portion thereof may be executed at a remote location, for example, a provider of Internet-based, or cloud, services. Further, the benefits administrator 200 may include multiple providers, where each provider has a portion of or various combinations of the afore-described computer system 210 and each provider may execute a portion of the claims processing steps described herein.

A bank 300 includes a computer system 310 to manage customer accounts. The computer system 310 may include one or more computers, servers, workstations, terminals, or combinations thereof at various locations throughout the facilities of the bank 300. An exemplary computer includes a processing unit 312, a user interface 314, such as a mouse, keypad, trackball, or touch-screen, and a monitor 316. The processing unit 312 includes an internal memory device, such as a hard-drive, or is connected to an external memory device to store customer account information. It is contemplated that the external memory device may be, for example, a local device such as an external hard-drive or a remote device, such as a remote server. The processing unit 312 is configured to execute one or more applications. The processing unit 312 is connected to the Internet 500 via any suitable network interface 311.

A pharmacy 400 includes a computer system 410 to process patients' prescriptions and to manage the pharmaceutical inventory. The computer system 410 may include one or more computers, servers, workstations, terminals, or combinations thereof at various locations throughout the facilities of the pharmacy 400. An exemplary computer includes a processing unit 412, a user interface 414, such as a mouse, keypad, trackball, or touch-screen, and a monitor 416. The processing unit 412 includes an internal memory device, such as a hard-drive, or is connected to an external memory device. It is contemplated that the external memory device may be, for example, a local device such as an external hard-drive or a remote device, such as a remote server. The processing unit 412 is configured to execute one or more applications to process patients' prescriptions. The processing unit 412 is connected to the Internet 500 via any suitable network interface 411.

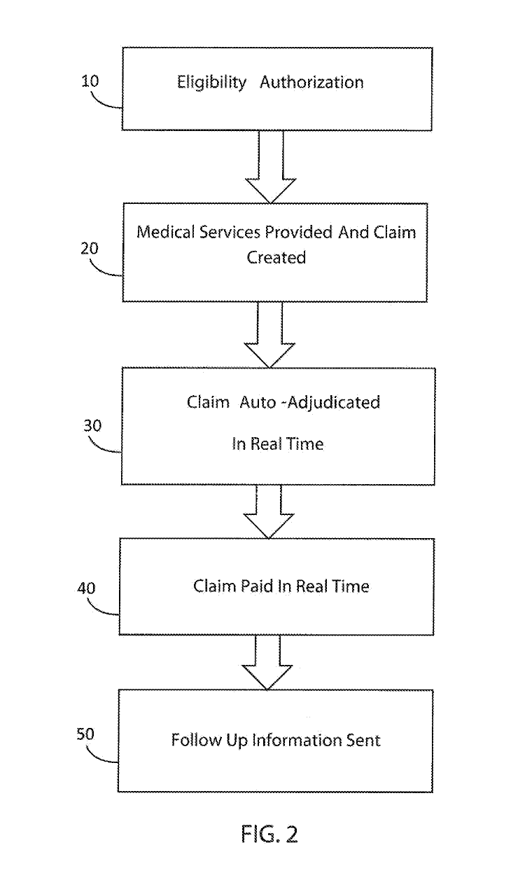

Referring next to FIG. 2, a method of paying claims in real-time according to one embodiment of the invention is illustrated. At step 10, a determination is made regarding the eligibility of a claim with respect to a particular patient to participate in real-time claim payment. If the patient and the patient's insurance is eligible for real-time claim payment, the service provider 100 attends to the patient and generates a claim listing the services received by the patient, as shown in step 20. At step 30, the claim is transmitted to the benefits administrator 200 which, subsequently, processes the claim in real-time. If the claim is successfully processed, the benefits administrator 200 directs payment to the service provider, also in real-time, as shown in step 40. At step 50, the benefits administrator 200 and/or the service provider 100 may follow up with the patient regarding the visit to the service provider 100. Each of these steps is discussed in more detail below.

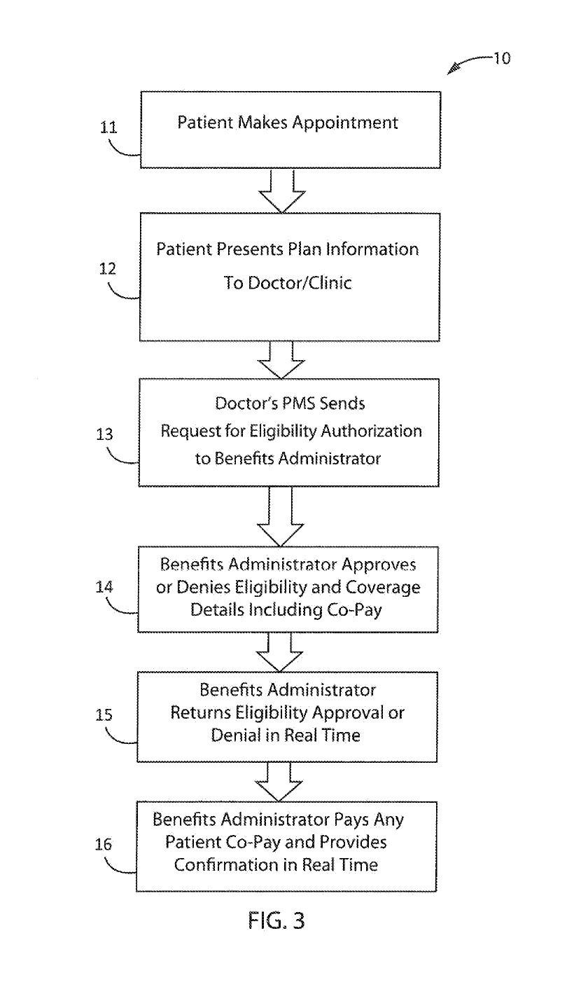

Turning then to FIG. 3, additional steps for determining eligibility of a claim for real-time claim payment 10 are disclosed. At step 11, a patient makes an appointment with the service provider 100. The appointment may be made in advance, for example, for a general practitioner or a specialist or spontaneously, for example, at an urgent care clinic or a hospital. The patient provides information regarding the patient's insurance provider and insurance plan to the service provider 100 at step 12. The information is typically contained on an insurance card that the patient provides to the service provider 100. Optionally, the service provider 100 has a patient interface device 118 configured to receive the information regarding the patient's insurance provider. The patient interface device 118 may be configured to communicate wirelessly with a patient's electronic device, such as a mobile phone or tablet computer to receive the information. The patient interface device 118 may be a card reader through which an identification card is passed. The insurance information may be encoded on the identification card and read by the card reader. According to still another embodiment of the invention, the insurance information may have been previously provided to the service provider 100, for example, on a prior visit or in advance via a phone call, facsimile transmission, or email and stored in the client database 120. The patient interface device 118 may be configured to verify the identity of the patient, for example, via a biometric scanner, such as a fingerprint reader, or via a card reader configured to read, for example, a patient's credit card. The identity information obtained by the patient interface device 118 may be provided to the computer system 110 to retrieve the previously stored insurance information from the client database 120. According to another option, the patient's insurance information may be retrieved by an employee of the service provider 100 from the client database 120 via the PMS 122 and verified by the patient. If the patient is a new patient or has new insurance information, the insurance information provided by the patient is stored in the client database 120 via the PMS 122. It is contemplated that still other suitable methods of providing the insurance information to the service provider 100 may be utilized without deviating from the scope of the invention.

At step 13, the PMS 122 generates an eligibility request and transmits the eligibility request to the benefits administrator 200. Optionally, the eligibility request or transmission of the request may be executed by the claim management module 124 or by a combination of the PMS 122 and the claim management module 124. The eligibility request is preferably formatted according to the requirements of the Health Insurance Portability and Accountability ACT (HIPAA) and, more preferably according to the Electronic Data Interchange (EDI) 5010 270 HIPAA Format Request for Eligibility. The eligibility request includes, among other things, the patient's insurance information. The processing unit 112 for the service provider 100 embeds the EDI message in a transport protocol and transmits the eligibility request via the network interface 111 and the Internet 500 to the benefits administrator 200.

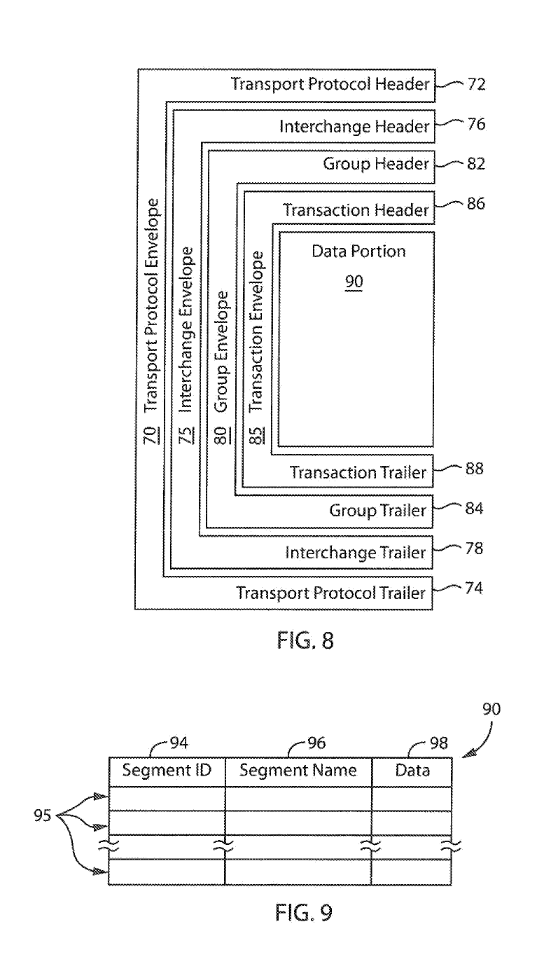

With reference to FIG. 8, the EDI message includes an interchange envelope 75, a group envelope 80, and a transaction envelope 85. The interchange envelope 75 includes an interchange header 76 that defines the properties of the EDI message (e.g., sender, receiver, date, time, and version) and an interchange trailer 78 that defines the end of the interchange envelope 75. The group envelope 80 includes a group header 82 that defines the collection of transaction sets that may be included in the group and that further includes message properties (e.g., sender, receiver, date, time, and version) and a group trailer 84 that defines the end of the group envelope 80. The transaction envelope 85 includes a transaction header 86 that defines the transaction contained within the EDI message and a transaction trailer 88 that defines the end of the transaction envelope 85. A Data Portion 90 of the EDI message is embedded within the transaction envelope and contains the data to be transmitted by the EDI message. With reference also to FIG. 9, the Data Portion 90 may include multiple segments 95 where each segment 95 is defined by a segment identification 94, a segment name 96 and segment data 98. The EDI message is further embedded within any suitable transport protocol for transmission via a network medium. According to the illustrated embodiment, the EDI message is embedded within a transport protocol envelope 70 that includes a transport protocol header 72 defining the properties of the message as required by the transport protocol and a transport protocol trailer 74 defining the end of the transport protocol envelope 70. The transport protocol may be selected from, but is not limited to Transmission Control Protocol/Internet Protocol (TCP/IP), Simple Object Access Protocol (SOAP), Web Services Description Language (WSDL), Hypertext Transfer Protocol (HTTP), and Multi-Purpose Internet Mail Extensions (MIME).

Referring again to FIG. 3, the benefits administrator 200 receives the eligibility request and processes the insurance information to determine whether the patient is eligible for real time claims payment, as shown at step 14. The processing unit 212 of the benefits administrator 200 receives the embedded EDI message from the Internet 500 via its respective network interface 211 and extracts the eligibility request from the transport protocol. The claim processing system 220 extracts the insurance information from the Data Portion 90 of the EDI message for the eligibility request and determines whether the insurance provider participates in real-time payment of a claim. According to one embodiment of the invention, the claim processing system 220 compares the insurance information to a list of participating insurance providers stored in either the internal or external memory device of the computer system 210 for the benefits administrator 200. According to another embodiment of the invention, the claim processing system 220 is configured to communicate with a processing unit of an insurance provider (not shown) to determine whether the insurance provider and/or a specific plan of the insurance provider is participating in real-time claims payment.

After performing the eligibility verification, the benefits administrator 200 generates a response to the service provider 100, as shown in step 15. The eligibility response is preferably formatted according to the requirements of HIPAA and, more preferably according to the EDI 5010 271 HIPAA Format Response to a Request for Eligibility. The Data Portion 90 of the EDI 5010 271 HIPAA Format Response includes either an approval or a denial of eligibility for the insurance provider and the insurance plan for real-time claims payment. The processing unit 212 for the benefits administrator 200 embeds the EDI message in a transport protocol and transmits the response to the eligibility request via the network interface 211 and the Internet 500 to the service provider 100.

If a patient is eligible for real-time claims payment, the benefits administrator 200 may be configured to pay the patient co-pay to a bank 300 which maintains an account 320 for the service provider 100, as shown in step 16. The benefits administrator 200 may be configured to process payment via the Automated Clearing House (ACH). A patient may provide account information of, for example, a savings account, a checking account, a credit or debit account, a health savings account, or any other suitable account from which funds may be withdrawn. The account information may be provided at the service provider 100 and transferred by the PMS 122 or claim management module 124 to the payment processing system 222 of the benefits administrator 200 via the Internet 500. Optionally, the account information may be provided in advance directly to the benefits administrator 200 or to the insurance provider by the patient, for example, upon enrollment in the insurance plan. The payment processing system 222 initiates a transaction via the ACH to transfer the amount of the co-pay to the account 320 for the service provider. Confirmation of the transaction may be transmitted by the benefits administrator 200 both to the service provider 100 and to the patient.

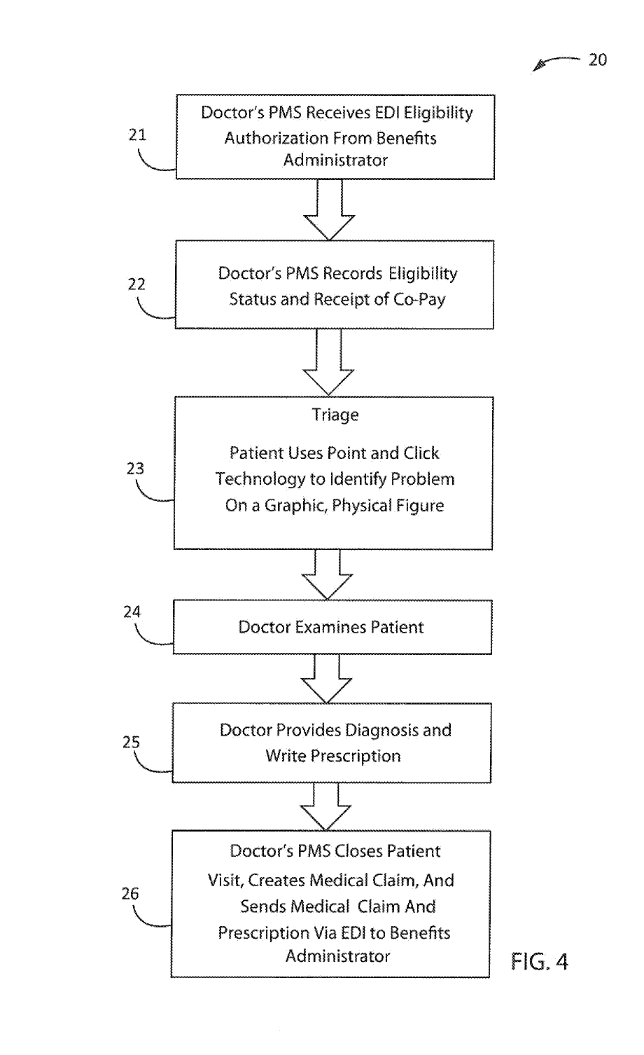

Turning next to FIG. 4, additional steps for providing service and generating a claim 20 are disclosed. At step 21, the PMS 122 of the service provider 100 receives the EDI message containing the response to the eligibility request from the benefits administrator 200. The PMS 122 extracts the eligibility status of the patient from the EDI message and stores the eligibility status in the memory device for the computer system 210. If the benefits administrator 200 processed the patient's co-pay, the PMS 122 may additionally receive and record a receipt confirming payment of the co-pay, as shown at step 22. Optionally, the service provider 100 may be configured to process the co-payment while the remainder of the services remains eligible for real-time payment by the benefits administrator 200.

The patient is next examined by the service provider 100. According to the illustrated embodiment, the patient may provide an initial indication of existing problems on a graphical interface, as illustrated at step 23. Optionally, the patient may verbally identify problems to a nurse, a physician's assistant, or to a physician. The identified problems are entered into the patient's chart either electronically or in paper form. At step 24, the service provider 100 examines the patient in response to the identified problems. The service provider 100 may be, but is not limited to, a general practice physician, a specialist, a nurse, or other medical technician such as an x-ray or imaging technician. The service provider 100 enters the service provided into the PMS 122 and, if required, further enters a prescription or other corrective measure, as shown in step 25. Once the service has been provided, the service provider closes the visit within the PMS 122, as shown in step 26. The claim management module 124 generates a claim which identifies the services provided. The claim is preferably generated according to EDI 5010 837 HIPAA Format. The Data Portion 90 of the EDI message includes, for example, the date of service provided, the appropriate procedure code, and the payer responsibility. The processing unit 112 for the service provider 100 embeds the EDI message in a transport protocol and transmits the claim and prescription information to the benefits administrator 200 via the Internet 500.

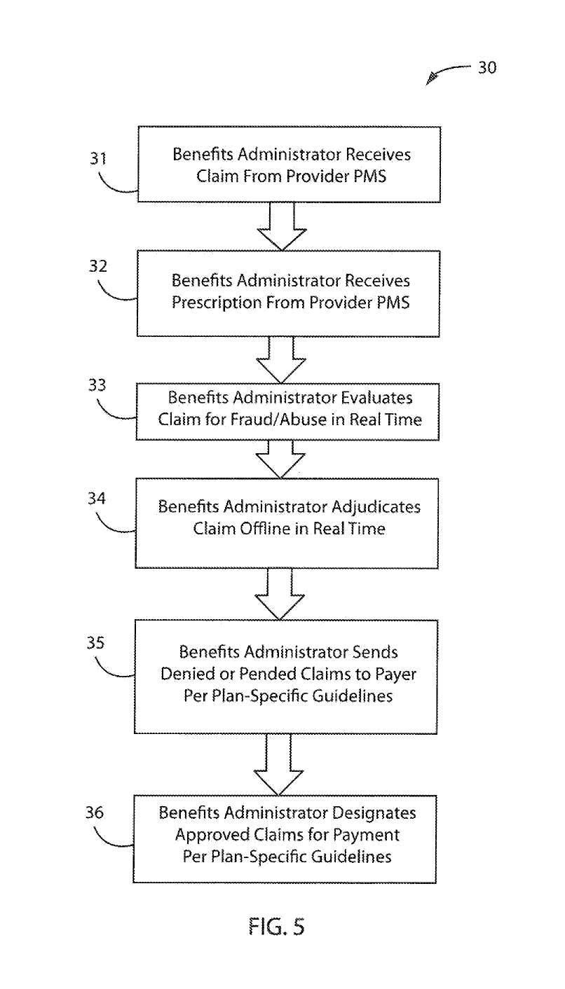

Turning next to FIG. 5, additional steps for processing each of the claims in real-time 30 are disclosed. At step 31, the claim processing system 220 receives the claim from the service provider 100. If a prescription was also transmitted, the benefits administrator 200 receives the prescription information from the service provider 100 at step 32.

At step 33, the claim processing system 220 of the benefits administrator 200 is configured to evaluate the claim data to determine whether potential fraud and/or abuse of insurance providers are present. The claim processing system 220 may, for example, compare the claim data to exemplary claim data stored on the computer system 210 or available from a remote source via the network interface 211 of the benefits administrator 200. If for example, the cost of the service provided exceeds the cost of the exemplary claim data by a predetermined amount or if the frequency at which a service provider 100 submits claims for a specific service exceed a frequency expected in the exemplary claim data, the benefits administrator 200 may flag the claim for further processing and reject real-time payment of the claim.

At step 34, the claim processing system 220 of the benefits administrator 200 adjudicates the claim. Adjudication of the claim determines, for example, whether the service provider submitted a clean claim and whether the claim is payable, where a clean claim is properly formatted and includes the required information. In order to determine whether a claim is a clean claim, the claim processing system 220 may initially obtain a model claim. The model claim may be stored, for example on the memory device of the computer system 210 for the benefits administrator 200. The model claim may be formatted in the EDI format such that segments from an EDI message transmitted from the service provider may be compared to the segments in the model claim. Optionally, the model claim may be stored in any suitable format and the claim processing system 220 may be configured to convert the EDT message containing the submitted claim to the corresponding format of the model claim for comparison. In order to identify a claim as a clean claim, each data segment from the submitted claim satisfies predefined criteria including, but not limited to acceptable ranges of data, acceptable lengths of data fields, predefined codes, and/or predefined formats of data present in the Data Portion 90 of the EDI message. If the claim is not a clean claim, the claim processing system 220 may further execute to auto-correct the claim. Certain errors, including but not limited to, typographical errors or incomplete data fields may be automatically corrected and the corrected claim may subsequently be processed to determine whether the claim is payable. Correction of the error may occur by changing the incorrect segment to match the corresponding segment in the model claim.

Adjudication of the claim also compares the service provided to a list of services payable by the insurance provider and, more particularly, by the patient's insurance plan from the insurance provider. Each plan may define a set of services eligible for real-time claims payment and a set of services requiring additional processing. It is contemplated that one claim submitted by the service provider 100 may identify services that qualify for real-time payment and services that require additional processing. The claims processing system 220 evaluates claims such that those services that qualify for real-time payment are paid immediately while those services that require additional processing are transmitted to the insurance provider in accordance with the plan guidelines. Adjudication of the claim may also determine that a claim is not properly payable under the plan guidelines and deny the claim. At step 35, those claims, or partial claims, that are denied or identified as requiring further processing are transmitted to the insurance provider in accordance with the plan guidelines. The benefits administrator 200 may also send the service provider 100 a response to the claim identifying those services that were denied or require further processing. At step 36, those claims that are approved for real-time payment are passed to the payment processing system 222.

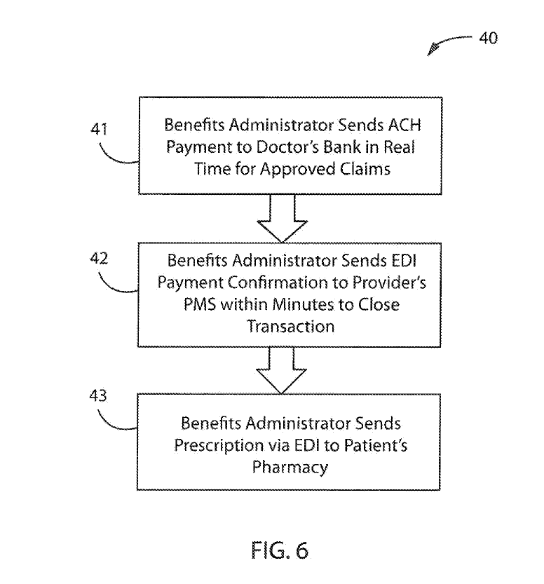

Turning then to FIG. 6, additional steps for real time payment of the claims are disclosed. At step 41, the payment processing system 222 initiates a payment to the bank 300 at which the service provider has established an account 320. In order to facilitate real-time claims payment, the insurance provider establishes an account from which funds may be withdrawn. The insurance provider's account includes a sufficient balance to make payment of expected claims and may be replenished by the insurance provider if a balance drops below a certain level. The account information for the insurance provider is provided to the benefits administrator 200, for example, when the insurance provider is initially established as a provider managed by the benefits administrator 200. Similarly, the service provider 100 provides information about the service provider's account 320 to the benefits administrator either during an initial enrollment procedure or on a per claim basis. The payment processing system 222 initiates the payment to the service provider from the insurance provider via an ACH transaction.

The payment processing system 222 receives confirmation of the transaction within seconds or minutes and, at step 42, transmits an EDI message including confirmation of the payment to the service provider 100. Either the PMS 122 or the claim management module 124 at the service provider 100 may be configured to receive confirmation of the payment and credits the patient's account at the service provider 100. If a prescription was transmitted from the service provider 100 to the benefits administrator 200, the prescription information may be included in the Data Portion 90 of an EDI message and the prescription processing system 224 transmits the EDI message to the pharmacy 400 via the Internet 500, as shown at step 43. The pharmacy 400 may then fill the prescription such that the prescription is available upon the patient's arrival. Thus, the service provider 100 receives payment for approved services in real-time, improving the efficiency of the office and increasing reliability of cash flow in the office. The increased efficiency of the claims process, may reduce administrative costs for the service provider 100 associated with billing and collection of fees. In return for the increased efficiency and reduced costs for an insurance provider accepting real-time payment of claims, the insurance provider may negotiate increased discounts for the services provided by the service provider 100.

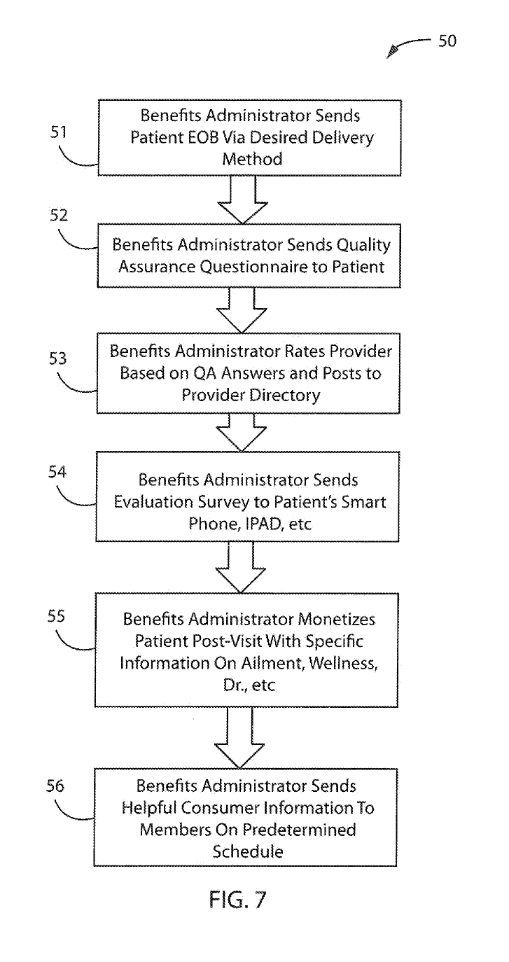

Turning next to FIG. 7, additional follow up steps performed by the benefits administrator 200 are disclosed. The follow up steps may be performed in real-time, at a later time, or a combination thereof. At step 51, the benefits administrator 200 delivers an Explanation of Benefits (EOB) to the patient. The EOB may be delivered electronically in real-time, for example, to an email address accessible via a smart phone, tablet computer, or other processing device. Optionally, a paper statement may be mailed out to the patient. The EOB identifies, for example, the services provided, the claim submitted by the service provider, and those services that were covered, adjusted, or denied in whole or in part. At step 52, the benefits administrator 200 may send a quality assurance questionnaire to the patient. The patient may provide feedback on the quality of services delivered by the service provider 100. At step 53, the benefits administrator 200 maintains a record of the responses submitted by patients. The benefits administrator 200 may generate a database of the results to the quality assurance questionnaire and generate a ranking system in a directory of service providers 100. At step 54, the benefits administrator 200 may send the evaluation survey to a patient's mobile electronic device such as a smart phone or tablet computer. At step 55, the benefits administrator 200 may further enhance the patient's visit by providing additional information regarding the condition for which they received services or related information to improve the patient's health or wellness. At step 56, the benefits administrator 200 may further be configured to generate periodic transmissions to the patient, either via electronic or paper communications, including, for example, reminders for follow up visits or periodic updates regarding the condition for which they received services.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A method for real-time claims payment, comprising the steps of:
generating a claim submission with a practice management system executing on a computer at a service provider, wherein the claim submission identifies at least one service provided;
transmitting the claim submission from the computer at the service provider to a remote server at a benefits administrator via a network;
verifying that the claim submission is a clean claim with a claim processing system executing on the remote server;
initiating a payment in real-time from the claim processing system for the at least one service provided, wherein the payment is credited to an account for the service provider; and
transmitting a payment acknowledgement from the claim processing system on the remote server to the claim management module executing on the computer at the service provider via the network in real-time.

2. The method of claim 1 wherein the claim submission is a first Electronic Data interchange (EDI) message and the payment acknowledgment is a second EDI message.

3. The method of claim 2 further comprising the initial steps of:
entering a patient's insurance information in the practice management system;
generating an eligibility request with a claim management module executing on the computer at the service provider, wherein the eligibility request includes the patient's insurance information;
transmitting the eligibility request from the computer at the service provider to the remote server via the network;
extracting an insurance provider from the patient's insurance information in the eligibility request with the claim processing system;
verifying that the insurance provider is eligible for real-time claims payment;
generating an eligibility response with the claim processing system on the remote server, wherein the eligibility response identifies whether the insurance provider is eligible for real-time claims payment; and
transmitting the eligibility response from the remote server to the claim management module executing on the computer at the service provider via the network.

4. The method of claim 3 wherein the eligibility request is a third Electronic Data Interchange (EDI) message and the eligibility response is a fourth EDI message.

5. The method of claim 3 wherein the step of entering a patient's insurance information includes reading one of an identity of a patient and the patient's insurance information with a patient interface device.

6. The method of claim 2 wherein the step of verifying that the claim submission is a clean claim includes the steps of:
reading a model data portion stored on a memory device operatively connected to the remote server, wherein the model data portion corresponds to the at least one service provided and wherein the model data potion defines a plurality of segments and a desired format for each of the plurality of segments; and
verifying that a format of each segment of a data portion of the first EDI message corresponds to the desired format for each of the plurality of segments in the model data portion.

7. The method of claim 6 wherein the step of verifying that the claim submission is a clean claim further includes the steps of:
identifying at least one error between the format of one segment of the data portion of the first EDI message and the desired format for the corresponding segment in the model data portion;
correcting the at least one error such that the format of the segment of the data portion of the first EDI message matches the desired format for the corresponding segment in the model data portion; and
verifying that the format of each segment of the data portion of the first EDI message corresponds to the desired format for each of the plurality of segments in the model data portion.

8. A method for real-time claims payment, comprising the steps of:
receiving a claim submission from a service provider at a remote server via a network, wherein the claim submission identifies at least one service provided;
verifying that the claim submission is a clean claim with a claim processing system executing on the remote server;
initiating a payment in real-time from the claim processing system for the at least one service provided to an account for the service provider; and
transmitting a payment acknowledgement from the claim processing system on the remote server to the service provider via the network in real-time.

9. The method of claim 8 wherein the claim submission is a first Electronic Data Interchange (EDI) message and the payment acknowledgment is a second EDI message.

10. The method of claim 9 further comprising the initial steps of:
receiving an eligibility request from a claim management module executing on the computer at the service provider by the remote server via the network, wherein the eligibility request includes insurance information for a patient visiting the service provider;
extracting an insurance provider from the patient's insurance information in the eligibility request with the claim processing system;
verifying that the insurance provider is eligible for real-time claims payment;
generating an eligibility response with the claim processing system on the remote server, wherein the eligibility response identifies whether the insurance provider is eligible for real-time claims payment; and
transmitting the eligibility response from the remote server to the claim management module executing on the computer at the service provider via the network.

11. The method of claim 10 wherein the eligibility request is a third Electronic Data Interchange (EDI) message and the eligibility response is a fourth EDI message.

12. The method of claim 9 wherein the step of verifying that the claim submission is a clean claim includes the steps of:
reading a model data portion stored on a memory device operatively connected to the remote server, wherein the model data portion corresponds to the at least one service provided and wherein the model data potion defines a plurality of segments and a desired format for each of the plurality of segments; and
verifying that a format of each segment of a data portion of the first EDI message corresponds to the desired format for each of the plurality of segments in the model data portion.

13. The method of claim 12 wherein the step of verifying that the claim submission is a clean claim further includes the steps of:
identifying at least one error between the format of one segment of the data portion of the first EDI message and the desired format for the corresponding segment in the model data portion;
correcting the at least one error such that the format of the segment of the data portion of the first EDI message matches the desired format for the corresponding segment in the model data portion; and
verifying that the format of each segment of the data portion of the first EDI message corresponds to the desired format for each of the plurality of segments in the model data portion.

14. A method for real time claims payment, comprising the steps of:
generating a first Electronic Data Interchange (EDI) message, corresponding to a claim submission, with a practice management system executing on a computer at a service provider, wherein a data portion of the first EDI message identifies at least one service provided;
embedding the first EDI message within a transport protocol configured to be transmitted on a network;
transmitting the first EDI message from the computer at the service provider to a remote server at a benefits administrator via the network;
extracting the first EDI message from the transport protocol at the remote server;
verifying that the data portion of the first EDI message defines a clean claim with a claim processing system executing on the remote server;
generating an Automated Clearing House (ACH) transaction in real-time from the claim processing system for the at least one service provided, wherein the ACH transaction includes details of payment to the service provider for the at least one service provided;
generating a second EDI message, corresponding to a payment acknowledgement, with the claim processing system on the remote server;
embedding the second EDI message within the transport protocol;
transmitting the second EDI message from the remote server to the computer at the service provider via the network;
extracting the second EDI message from the transport protocol at the service provider; and
crediting the payment for the service provided to the patient at the service provider.

15. The method of claim 14 wherein the step of verifying that the data portion of the first EDI message defines a clean claim further includes the steps of:
reading a model data portion stored on a memory device operatively connected to the remote server, wherein the model data portion corresponds to the at least one service provided and wherein the model data potion defines a plurality of segments and a desired format for each of the plurality of segments; and
verifying that a format of each segment of the data portion of the first EDI message corresponds to the desired format for each of the plurality of segments in the model data portion.

16. The method of claim 15 wherein the step of verifying that the claim submission is a clean claim further includes the steps of:
identifying at least one error between the format of one segment of the data portion of the first EDI message and the desired format for the corresponding segment in the model data portion;
correcting the at least one error such that the format of the segment of the data portion of the first EDI message matches the desired format for the corresponding segment in the model data portion; and
verifying that the format of each segment of the data portion of the first EDI message corresponds to the desired format for each of the plurality of segments in the model data portion.

17. The method of claim 14 further comprising the initial steps of:
entering a patient's insurance information in the practice management system;
generating a third EDI message, corresponding to an eligibility request, with a claim management module executing on the computer at the service provider, wherein a data portion of the third EDI message includes the patient's insurance information;
embedding the third EDI message within the transport protocol;
transmitting the third EDI message from the computer at the service provider to the remote server via the network;
extracting the third EDI message from the transport protocol at the remote server;
extracting an insurance provider from the data portion of the third EDI message with the claim processing system on the remote server;
verifying that the insurance provider is eligible for real-time claims payment;
generating a fourth EDI message, corresponding to an eligibility response, with the claim processing system on the remote server, wherein the eligibility response identifies whether the insurance provider is eligible for real-time claims payment
embedding the fourth EDI message within the transport protocol;
transmitting the fourth EDI message from the remote server to the computer at the service provider via the network; and
extracting the fourth EDI message from the transport protocol at the service provider.

18. The method of claim 17 wherein the step of entering a patient's insurance information includes reading one of an identity of a patient and the patient's insurance information with a patient interface device.
